(19) United States
(12) Patent Application Publication
(10) Pub. No.: US 2025/0084328 A1
(43) Pub. Date: Mar. 13, 2025

(54) PRODUCTION OF BASE OIL COMPONENTS FROM ORGANIC MATERIAL

(71) Applicant: Neste Oyj, Espoo (FI)

(72) Inventors: Rami PIILOLA, Porvoo (FI); Jukka MYLLYOJA, Porvoo (FI); Mika KETTUNEN, Porvoo (FI); Kaisa LAMMINPÄÄ, Porvoo (FI); Petro SILVONEN, Porvoo (FI); Pekka AALTO, Porvoo (FI)

(73) Assignee: Neste Oyj, Espoo (FI)

(21) Appl. No.: 18/725,474

(22) PCT Filed: Dec. 30, 2022
(86) PCT No.: PCT/FI2022/050884

§ 371 Date: Jun. 28, 2024

(30) Foreign Application Priority Data
Dec. 30, 2021 (FI) 20216368
Dec. 30, 2021 (FI) 20216369
Dec. 30, 2021 (FI) 20216372
Dec. 30, 2021 (FI) 20216374
Dec. 30, 2021 (FI) 20216376

(51) Int. Cl. C10L 1/04

(52) U.S. Cl. CPC C10L 1/04; C10L 2200/0476; C10L 2290/543

(57) ABSTRACT

The present disclosure relates to a base oil hydrocarbon composition containing a total paraffin content of from 50 wt. % to 65 wt. %, of which at least 90% are isomerised paraffins, a naphthenes content of from 25 wt. % to 35 wt. %, aromatics in an amount of 4 wt. % to 16 wt. % based on a total weight of the composition, and wherein the composition has a pour point of −26° C. to −32° C. and a kinematic viscosity 100° C. of 7 to 17 cSt. The base oil hydrocarbon composition is obtained from a feedstock containing organic material of biological origin, such as crude tall oil. A process produces a base oil hydrocarbon product from a feedstock including organic material of biological origin.

### FIELD OF THE INVENTION

The present invention relates to a base oil hydrocarbon composition, particularly obtained from renewable material. The present invention also relates to a process for producing hydrocarbons from recycled and renewable organic material, in particular organic material of biological origin comprising a high amount of impurities, such as, nitrogen, silicon, chloride and phosphorus compounds, as well as metals. The present process is particularly suitable for challenging feedstock, which would typically not be introduced directly to a hydrogenation process using sensitive catalysts.

One of the aims of the invention is to present a method to produce hydrocarbons suitable for use as base oil components. The base oil components can be produced in the same process that also produces middle distillate components.

### BACKGROUND OF THE INVENTION

The use of various oils and fats in production of middle distillate components suitable as fuels especially for diesel engines is well known. Renewable and recycled organic material of biological origin has been used as feedstock in production of fuel components mainly to reduce use of fossil based feedstock to tackle global warming issues. Hydrogenated vegetable oil (HVO) is a promising alternative to fossil based middle distillate fuels. Although HVO is mainly produced from vegetable oils, also other sources such as animal fats and algae oils can be used.

There is still a need for alternative non-fossil based sources and processes to produce other hydrocarbons components besides middle distillate fuels. Base oil components suitable to use in lubrication, isolation and other non-fuel pur-poses should also be produced from renewable and recycled organic material. However, there is still a need for an effective, economical, stable and sensible process to produce base oil components from renewable and recycled organic material.

In addition, many renewable and recycled organic material sources that could be used to produce hydrocarbon components, contain high amounts of impurities such as nitrogen, silicon, chloride and phosphorus compounds, and metals. These and other impurities weaken the possibility of many organic materials to be used as feedstock or lowers the quality of the products.

Another challenge of using organic material of biological origin as feedstock is the yield. All possible products and ranges of hydrocarbons should be use-able as valuable products, in order to make the whole process both environmentally but also economically sensible.

### BRIEF DESCRIPTION OF THE INVENTION

An object of the present invention is thus to provide a process and a product to solve the above problems. The present process is particularly suitable for challenging feedstock, which would typically not be introduced directly to a hydrogenation process using sensitive catalysts. With challenging feedstock is meant herein low-quality feedstock containing e.g. phosphorus and metal impurities, which are difficult to remove by regular pretreatment methods, such as degumming or bleaching, and which cause problems for catalysts, such as deactivation, when used in the subsequent hydrotreatment processes. Moreover, challenging feedstock may include chemically challenging materials like resin acids and unsaponifiable matter included in e.g. crude tall oil. Low-quality or challenging feedstock would typically not be introduced to a hydrogenation process, which uses sensitive catalysts.

The objects of the invention are achieved by a product and a process as characterized by what is stated in the independent claims. The preferred embodiments of the invention are disclosed in the dependent claims.

The present invention therefore provides a base oil hydrocarbon composition comprising
a total paraffin content of from 50 wt. % to 65 wt. %, of which at least 90% are isomerised paraffins,
a naphthenes content of from 25 wt. % to 35 wt. %,
aromatics in an amount of 4 wt. % to 16 wt. % based on total weight of composition, and
wherein the composition has a pour point of −26° C. to −32° C. and a kinematic viscosity 100° C. of 7 to 17 cSt.

The present invention also provides a process for producing a base oil hydrocarbon product from a feedstock comprising organic material of biological origin.

### DETAILED DESCRIPTION OF THE INVENTION

The present invention provides a base oil hydrocarbon composition comprising
a total paraffin content of from 50 wt. % to 65 wt. %, of which at least 90% are isomerised paraffins,
a naphthenes content of from 25 wt. % to 35 wt. %,
aromatics in an amount of 4 wt. % to 16 wt. % based on total weight of composition, and
wherein the composition has a pour point of −26° C. to −32° C., a kinematic viscosity 100° C. of 7 to 17 cSt.

In one embodiment the base oil hydrocarbon composition is obtained from a feedstock comprising organic material of biological origin, as herein described. The organic material of biological origin herein can also be renewable material.

In one embodiment of the invention the base oil hydrocarbon composition has a kinematic viscosity 40° C. of 95 to 170 mm²/s, a viscosity index from 65 to 45 or a density of from 885 kg/m³ to 895 kg/m³. Kinematic viscosity at 40° C. and 100° C. is measured according to ENISO3104, viscosity index is measured according to ASTM2270 and density is measured at 50° C. according to ENISO12185.

In one embodiment the base oil hydrocarbon composition of the present invention is produced by any process herein described. Preferably the base oil hydrocarbon composition is produced from a feedstock comprising organic material of biological origin, more preferably the feedstock comprises crude tall oil (CTO), which optionally contains tall oil pitch (TOP).

It has surprisingly been found that good quality naphthenic base oil (API Group V) may be obtained, from the base oil hydrocarbon composition of the current invention, having better pour point compared to corresponding fossil products on the market. Likewise, the renewable base oil contains less aromatics compared to commercial fossil products for the 9-12 cSt (KV100) products. Moreover, the oxidation and thermal stabilities seem good enabling long shelf life.

It is further suggested to collect the heavy bottom fraction (may be directed elsewhere, as well) not continuously but according to need, and to store it e.g. in a storage container ready for use depending on demand. This is a “side product” in the manufacture of middle distillate, but to make the best use from the renewable carbons (carbon efficiency) may be processed into a further consumer product.

The present invention also provides a process for producing base oil hydrocarbon product from a feedstock comprising organic material of biological origin comprising providing a feedstock comprising organic material of biological origin and pre-treating the feedstock in one or more pre-treatment stages to obtain a purified feedstock.

As used herein the term “organic material of biological origin” refers to organic material, i.e. material containing carbon. The organic material is of biological origin, i.e. from natural resource such as but not limited to plants, trees, algae, microbes but also animal sources are possible. Organic material of biological origin is here meant to exclude fossil based organic material. The organic material of biological origin herein can also be renewable material. The organic material suitable in the present process typically contain organic compounds such as fatty acids, resin and rosin acids and other lipophilic compounds but also other organic compounds.

Waste and residues containing organic material may further be used as feedstock, while containing compounds and/or impurities that are not allowed or just spoiling the usability thereof for e.g. food or feed or cosmetics applications.

The renewable character of carbon-containing compositions, such as feedstocks and products of biological origin i.e. renewable feedstock and products, can be determined by comparing the 14C-isotope content of the feedstock to the 14C-isotope content in the air in 1950. The 14C-isotope content can be used as evidence of the renewable origin of the feedstock or product. Carbon atoms of renewable material comprise a higher number of unstable radiocarbon (14C) atoms compared to carbon atoms of fossil origin. Therefore, it is possible to distinguish between carbon compounds derived from biological sources, and carbon compounds derived from fossil sources by analysing the ratio of 12C and 14C isotopes. Thus, a particular ratio of said isotopes can be used to identify and quantify renewable car-bon compounds and differentiate those from non-renewable i.e. fossil carbon compounds. The isotope ratio does not change in the course of chemical reactions. Examples of a suitable method for analysing the content of carbon from biological sources is ASTM D6866 (2020). An example of how to apply ASTM D6866 to deter-mine the renewable content in fuels is provided in the article of Dijs et al., Radiocarbon, 48(3), 2006, pp 315-323. For the purpose of the present invention, a car-bon-containing material, such as a feedstock or product is considered to be of renewable origin if it contains 90% or more modern carbon, such as 100% modern carbon, as measured using ASTM D6866.

Particular examples of the feedstock comprising organic material of biological origin of the present invention include, but are not limited to, animal based fats and oils, such as suet, tallow, blubber, lard, train oil, milk fat, fish oil, poultry oil, and poultry fat; plant based fats and oils, such as sludge palm oil, rape-seed oil, canola oil, colza oil, sunflower oil, soybean oil, hemp oil, olive oil, linseed oil, cottonseed oil, mustard oil, palm oil, arachis oil, castor oil, coconut oil, lignocellulosic pyrolysis liquid (LPL), HTL biocrude, crude tall oil (CTO), tall oil pitch (TOP), crude fatty acid (CFA), tall oil fatty acid (TOFA) and distilled tall oil (DTO); microbial oils; algal oils; recycled fats or various waste streams of the food industry, such as used cooking oil, yellow and brown greases; free fatty acids, any lipids containing phosphorous and/or metals, oils originating from yeast or mold products, recycled alimentary fats; starting materials produced by genetic engineering, and any mixtures of said feedstocks.

In one embodiment of the current invention the feedstock comprising organic material of biological origin comprise pitch containing crude tall oil (CTO), residue and waste oils from palm oil production and/or recycled fats and oils.

In an embodiment of the present invention organic material of biological origin used as feedstock is selected from a group consisting of crude tall oil (CTO), tall oil pitch (TOP), tall oil fatty acid (TOFA), crude fatty acid (CFA) and distilled tall oil (DTO); more particularly the organic material of biological origin is crude tall oil (CTO) or tall oil pitch (TOP).

In addition or as an alternative, the organic material of biological origin can also be selected from acid oils, such as acidulated soapstock (ASK), technical corn oil (TCO), plant oil from plants of the family Brassicaceae (carinata oil), palm effluent sludge (PES) also called palm oil mill effluent (POME), used cooking oil (UCO), gutter oil and brown grease (BG).

As defined herein crude tall oil (CTO, CAS Registry Number 8002-26-4) is most frequently obtained as a by-product of either Kraft or Sulphite pulping processes and tall oil pitch (TOP, CAS number of 8016-81-7) is the residual bottom fraction from crude tall oil distillation processes.

Crude tall oil comprises resin acids, fatty acids, and unsaponifiables. Resin acids are a mixture of organic acids derived from oxidation and polymerization reactions of terpenes. The main resin acid in crude tall oil is abietic acid but abietic derivatives and other acids, such as pimaric acid are also found. Fatty acids are long chain monocarboxylic acids and are found in hardwoods and softwoods. The main fatty acids in crude tall oil are oleic, linoleic and palmitic acids. Unsaponifiables cannot be turned into soaps as they are neutral compounds which do not react with sodium hydroxide to form salts. They include sterols, higher alcohols and hydrocarbons. Sterols are steroids derivatives which also include a hydroxyl group.

Tall oil pitch (TOP) can be considered to be a UVCB substance (Substances of Unknown or Variable composition, Complex reaction product or Biological materials) under the REACH definition (ECHA; Guidance in a Nutshell, Identification and naming of substances under REACH and CLP; Version 2.0, April 2017). Composition of TOP according to Holmbom (1978) is presented in Table 1, wherein A, B, C, D denote ordinary grades of tall oil pitch received from three plants in Fin-land and E and F denote US grades investigated.

Tall oil pitch typically comprises from 34 to 51 wt. % free acids, from 23 to 37 wt. % esterified acids, and from 25 to 34 wt. % unsaponifiable neutral compounds of the total weight of the tall oil pitch. The free acids are typically selected from a group consisting of dehydroabietic acid, abietic and other resin acids. The esterified acids are typically selected from a group consisting of oleic and linoleic acids. The unsaponifiables neutral compounds are typically selected from a group consisting of diterpene sterols, fatty alcohols, sterols, and dehydrated sterols.

TABLE 1
Component Group Composition of Tall Oil Pitch (wt. % of pitch)^{a}

| Constituents | A | B | C | D | E | F |
|---|---|---|---|---|---|---|
| Free acids, total | 39.3 | 52.6 | 48.6 | 44.6 | 46.7 | 34.6 |
| Fatty acids | 1.4 | 1.8 | 1.3 | 0.8 | 1.3 | 2.4 |
| Resin acids | 10.6 | 12.5 | 9.7 | 6.1 | 3.3 | 6.5 |
| Other acids | 27.3 | 37.3 | 37.3 | 37.7 | 42.1 | 25.7 |
| Esterified acids, total | 30.6 | 23.2 | 23.3 | 26.8 | 27.9 | 37.8 |
| Fatty acids | 8.2 | 12.9 | 13.3 | 15.2 | 13.8 | 12.4 |
| Resin acids | 1.7 | 0.9 | 1.2 | 0.9 | 1.6 | 1.9 |
| Other acids | 20.7 | 9.4 | 8.8 | 10.7 | 12.5 | 23.5 |
| Equiv. weight for free | 648 | 591 | 716 | 642 | 873 | 719 |
| acids | | | | | | |

^{a}Holmbom B, and Erä V, 1978. Composition of Tall oil pitch, Journal of the American oil chemistry society, 55, pp. 342-344.

The term “crude fatty acid (CFA)” refers to fatty acid-containing materials obtainable by purification (e.g., distillation under reduced pressure, extraction, and/or crystallization) of CTO. The term “tall oil fatty acid (TOFA)” refers to fatty acid rich fraction of crude tall oil (CTO) distillation processes. TOFA typically comprises mainly fatty acids, typically at least 80 wt. % of the total weight of the TOFA. Typically, TOFA comprises less than 10 wt. % rosin acids.

The term “distilled tall oil (DTO)” refers to resin acid rich fraction of crude tall oil (CTO) distillation processes. DTO typically comprises mainly fatty acids, typically from 55 to 90 wt. %, and rosin acids, typically from 10 to 40 wt. % rosin acids, of the total weight of the DTO. Typically, DTO comprises less than 10 wt. % unsaponifiable neutral compounds of the total weight of the distilled tall oil.

Acid oils refers to by-products of alkali or physical refining of crude oils and fats. One example of acid oils are oils obtained by acidulation of soapstock (ASK), which contains free fatty acids, acylglycerols and other lipophilic compounds.

The term “technical corn oil” TCO refers to corn oil extracted through a dry milling process. In the dry milling process, corn grains are cleaned and ground directly to obtain a fine corn flour. This flour is then mixed with water, enzymes and other ingredients (cooking and liquefaction) to convert starch into simple sugars, then into glucose (saccharification). This glucose is fermented to produce ethanol, which is then removed by distillation and purified by dehydration. The remaining stillage (called distillers grain) is then processed further to expel technical corn oil (generally called “distillers corn oil” in the United States) through centrifugation. De-emulsifiers can be used to enhance separation of the TCO from the rest of the stillage.

The organic material can also comprise plant oil originating from a plant of the family Brassicaceae (carinata oil). The plant of the family Brassicaceae is selected from Brassica juncea (brown mustard), Brassica carinata (Ethiopian mustard), Brassica nigra (black mustard), Brassica rapa, Brassica rapa subsp. oleifera (field mustard), Brassica elongate (elongated mustard), Brassica nariosa (broad-baked mustard), Brassica rupestris (brown mustard), Brassica tournefortii (Asian mustard), Brassica napus, Brassica napus el, Sinapis hirta (mustard), Sinapis alba (white mustard), Sinapis arvensis, Nasturtium floridanum, Nasturtium gambellium, Nasturtium gronlandicum, Nasturtium microfullum, Nasturtium officinale, Nasturtium sordidum and combinations thereof. Preferably the plant is Brassica carinata.

The term “palm effluent sludge” (PES), also commonly referred to as palm oil mill effluent (POME) here refers to the voluminous liquid waste that comes from the sterilisation and clarification processes in milling oil palm. The raw effluent contains 90-95% water and includes residual oil, soil particles and sus-pended solids.

The term “used cooking oil” (UCO) refers to oils and fats that have been used for cooking or frying in the food processing industry, restaurants, fast foods and at consumer level, in households.

Gutter oil is a general term for oil that has been recycled. It can be used to describe the practice of restaurants re-using cooking oil that has already been fried before.

Brown grease (BG) means an emulsion of fat, oil, grease, solids, and water separated from wastewater in a grease interceptor (grease trap) and collected for use as feedstock.

In one embodiment the organic material of biological origin comprises crude tall oil (CTO) optionally including tall oil pitch (TOP), tall oil pitch (TOP), brown grease (BG), acidulated soapstock (ASK), technical corn oil (TCO), low quality animal fat (AF), Brassica carinata (BC), palm effluent sludge (PES) or any combination thereof, wherein these materials typically contain difficult to remove heavy molecular weight compounds, metal or phosphorus containing impurities.

In one embodiment the feedstock comprises crude tall oil (CTO), tall oil pitch (TOP), brown grease (BG) and acidulated soapstock (ASK).

In one embodiment the feedstock comprising organic material of biological origin comprises crude tall oil (CTO) and/or tall oil pitch (TOP). In one embodiment the feedstock comprising organic material of biological origin comprises resin acids from 10 wt. % to 30 wt. %, based on the total feedstock.

The process of the present invention further comprises a step of pre-treating the feedstock in one or more pre-treatment stages. The pre-treatment stages vary and are selected based on the feedstock and especially on the amount and type of impurities in the feedstock. The pre-treatment stages can be selected from heat treatment optionally followed by evaporation of volatiles; heat treatment with adsorbent (HTA) optionally followed by flash evaporation; degumming; bleaching or any combination thereof. The pre-treatment also typically comprises a step of removing impurities from the feedstock, including any suitable removal of solids from a liquid, including filtration, centrifugation and sedimentation; and removing volatiles from liquid, e.g. by evaporation. In the pre-treatment the feedstock comprising organic material of biological origin, as previously defined, is purified and a purified feedstock is obtained. With purification is meant herein that the amount of at least one impurity, such as metal impurity, phosphorus and silicon, is decreased in the feedstock as a result of the pre-treatment.

In one embodiment the pre-treatment is selected from heat treatment optionally followed by evaporation of volatiles, whereby the feedstock is heated at a temperature of from 80° C. to 325° C., preferably 180° C. to 300° C., more preferably 200° C. to 280° C., in a residence time from 1 to 300 min. The heat treatment can follow by an evaporation step, where especially silicon and phosphorous containing compounds are removed. An example of heat treatment of a feedstock comprising organic material can be found in WO 2020/016405. Heat treatment can also be followed by filtration as an addition or an alternative to evaporation. When the feedstock comprises brown grease or acidulated soapstock the pre-treatment comprising heat treatment with or without filter-aid (adsorbent) followed by filtration and possible bleaching.

In one embodiment the pre-treatment is selected from heat treatment with adsorbent (HTA) optionally followed by flash evaporation. HTA as pre-treatment is especially suitable when the feedstock comprises CTO and/or TOP, but also for other feedstock. Heat treatment with adsorbent (HTA) can be performed in a temperature from 180° C. to 325° C., preferably from 200° C. to 300° C., more preferably from 240° C. to 280° C., optionally in the presence of an acid. The adsorbent can be selected from alumina silicate, silica gel and mixtures thereof and is typically added in an amount of 0.1 wt. % to 10 wt. %, such as 0.5 wt. %. An example of HTA can be found in WO 2020/016410.

In one embodiment the pre-treatment is selected from bleaching. Bleaching can be conducted by acid addition in an amount of from 500 to 5000 ppm based on feed. The bleaching treatment can be performed in a temperature from 60° C. to 90° C. and including a drying step in 110° C. to 130° C. The bleaching is finished by a filtration step to remove formed solids and possible filter aids. In one example bleaching includes the following sequence
(1) acid addition 1000-4000 ppm citric acid (50% water) 85° C., 10 min;
(2) adsorbent/filter aid addition 0.1-1 wt. %, 85° C., 800 mbar, 20 min;
(3) drying 120° C., 80 mbar, 25 min
(4) filtering 120° C., 2.5 bar.

Both heat treatment (HT) and heat treatment with adsorbent (HTA) can be performed under pressure, the pressure can be 500 to 5000 kPa. Also water can be added before or during HT and HTA to a level of up to 5 wt. %, such as 1 wt. %-3 wt. %. The evaporation, e.g. performed by flashing can be performed after HT or HTA or any other pre-treatment stage and can be performed at about 160° C., such as from 150° C. to 225° C., in a pressure of 10 to 100 mbar (0.1 to 5 kPa).

For a feedstock comprising palm oil effluent sludge (PES) the pre-treatment can comprise acid degumming followed by solid removal from the liquid, using filtration of centrifugation. The degumming process can further be followed by a bleaching step.

In one embodiment of the invention the pre-treatment, comprises heat treatment (HT) and bleaching.

In one embodiment of the invention the pre-treatment, comprises heat treatment (HT) with alkali addition and bleaching.

In one embodiment of the invention the pre-treatment, comprises heat treatment with adsorption (HTA) followed by flash (removal of light components comprising Si components etc. by evaporation) and bleaching,

In addition, the pre-treatment may or may not include additional steps such as removal of solids (using technologies such as centrifugation or filtration) before and/or after HT or HTA, water washing, degumming, hydrolysis, distillation, strong acid treatment, 2nd bleaching or any combination of the mentioned methods.

The level and type of impurities vary with the organic material, but can also vary from one feedstock to another depending on source and how the organic material have been treated. Typical impurity levels of the most significant impurities are listed in Table 2 below.

TABLE 2
Typical impurities and ranges in different organic materials

| | P | N | Si | Tot Cl | metals* |
|---|---|---|---|---|---|
| | (ppm) | (ppm) | (ppm) | (ppm) | (ppm) |
| CTO | 1-100 | 100-500 | 1-100 | 1-10 | 10-1000 |
| TOP | 1-200 | 100-1500 | 1-500 | 1-20 | 30-1500 |
| PES | 5-100 | 30-500 | 0-100 | 1-50 | 20-1200 |
| UCO | 0-500 | 1-600 | 0-50 | 1-300 | 1-1000 |
| BG | 5-3500 | 50-5000 | 0-50 | 1-300 | 10-20000 |
| TCO | 0-100 | 20-100 | 0-20 | 1-20 | 1-200 |
| BC | 0-50 | 30-100 | 0-1 | 0-5 | 1-100 |
| AF | 0-700 | 1-3000 | 0-30 | 1-100 | 0-600 |

Metals = Ca, Mg, Na, Fe; in total

Different organic materials can be blended in the final feedstock to avoid unwanted reactions. For example, if the feed Cl content is over 100 ppm and simultaneously N content is over 1000 ppm it is possible that ammonium chloride NH₄Cl precipitation reaction takes place in pre-hydrotreatment step. In order to avoid this, organic material like BG, having a high Cl content and a high N content, are blended with organic material having a low Cl and/or N content, such as PES.

In one embodiment of the present invention the feedstock comprising organic material of biological origin comprises an impurity level of
nitrogen compounds from more than 30 ppm, preferably more than 50 ppm or 100 ppm, such as up to 5000 ppm;
silicon compounds from more than 1 ppm, preferably more than 5 ppm or more than 10 ppm or 30 ppm, up to 500 ppm;
phosphorous compounds from more than 5 ppm, preferably more than 10 ppm or 50 ppm, up to 3500 ppm;
chloride from more than 1 ppm, preferably more than 5 ppm or 10 ppm, up to 300 ppm; and/or
metals from more than 10 ppm, preferably more than 30 ppm or 50 ppm, up to 20000 ppm.

The amount of metals are given as the total sum of at least Ca, Mg, Na and Fe.

In one embodiment of the present invention at least one impurity selected from nitrogen, silicon, phosphorous, chloride and metals, is present in the feedstock prior to pre-treatment in high amount, such as for nitrogen over 1000 ppm, silicon over 100 ppm, phosphorous over 700 ppm, chloride over 60 ppm or metals over 4000 ppm.

In one embodiment of the current invention the one or more hydrotreatment stage(s) are selected from a pre-hydrotreatment step, a hydrotreatments step, an isomerisation step and any combination thereof, preferably the one or more hydrotreatment stage(s) comprise a pre-hydrotreatment step, a hydrotreatment step and an isomerisation step.

The pre-hydrotreatment step if present, is performed in conditions selected from:
a temperature range of 300° C. to 380° C., preferably of 320° C. to 360° C.;
a pressure range of 40 to 100 bar, preferably 40 to 80 bar, more preferably 50 to 70 bar;
a weight hourly space velocity (WHSV) of 0.2 1/h to 10 1/h, preferably 0.25 1/h to 1.5 1/h, more preferably 0.3 1/h to 1 1/h; and
a H₂/oil feed of 800 dm³/dm³ to 1200 dm³/dm³, preferably of 900 dm³/dm³ to 1100 dm³/dm³.

The catalyst used in the pre-hydrotreatment step is a typical hydrotreating catalyst such as Ni, Co, Mo, W or any combination thereof on a carrier such as alumina. Alternatively or in addition the catalyst in pre-hydrotreatment can also be a typically hydrocracking catalyst such as NiW on acidic supports (ASA, Zeolites). In one embodiment the catalyst in the pre-hydrotreatment is NiMo on alumina carrier. The pre-treatment step is typically carried out in a reactor with one or more catalyst beds. The extent of the pre-hydrotreatment depends on the organic material and level of impurities. The aim of the pre-treatment is to prepare the feed, e.g. to remove heteroatoms and other impurities, to such a level that the hydrotreatment can remove the rest of the heteroatoms and impurities prior to the isomerization. The feed to the hydrotreatment essentially contains only a minor amount of heteroatoms and other impurities compared to the feed to the pre-hydrotreatment.

As the purified feedstock subjected to the pre-hydrotreatment typically still, after pretreatment, contains heteroatoms, such as oxygen and nitrogen, the decrease of the amount of oxygen and/or nitrogen in the heteroatom containing feed compounds, such as triglycerides, may be depicted by using the term oxygen conversion. In this disclosure the term “oxygen conversion” is taken to mean the depletion, by a deoxygenation reaction, of the amount of oxygen contained in or bound to oxygen-containing feed compounds wherein the oxygen is depleted or removed from said feed compound. For example, oxygen contained in fatty acid is reacted with hydrogen (hydrodeoxygenation) to form water, which can be removed as a gaseous by-product and the corresponding oxygen depleted or oxygen-free hydrocarbon, thus formed at a 100% oxygen conversion.

In an embodiment, the oxygen conversion of the purified feedstock in the pre-hydrotreatment step, is adjusted to at least 60%, preferably at least 70%, more preferably at least 80%, such as at least 90% or even at least 95%. The maximum oxygen conversion in pre-hydrotreatment step is 99%. This is the conversion of oxygen containing compounds to oxygen-free compounds. The aim is to remove most of the oxygen already in the pre-hydrotreatment to allow optimal removal conditions for other heteroatoms, such as nitrogen, in the hydrotreatment step.

In an embodiment the nitrogen conversion of the purified feedstock in the pre-hydrotreatment step is lower than the oxygen conversion, such as 4 percentage points or 10 percentage points lower than the oxygen conversion. In one embodiment the nitrogen conversion of the purified feedstock in the pre-hydrotreatment step, is adjusted to at least 55%, preferably at least 65%, more preferably at least 75%, such as at least 90%. The maximum nitrogen conversion in pre-hydrotreatment step is 95%. The term “nitrogen conversion” is applied similarly to oxygen conversion and is herein taken to mean the conversion of nitrogen containing compounds to nitrogen-free compounds. Nitrogen in the nitrogen containing compounds also react with hydrogen and forms e.g. NH₃, which can be removed as a gaseous by-product.

In an embodiment, the conditions for pre-hydrotreatment and hydrotreatment are different from each other, particularly the temperature of hydrotreatment is at least 10° C. higher than in the pre-hydrotreatment.

Hydrodenitrogenation (HDN) of nitrogen containing compounds is typically more difficult than the hydrodeoxygenation (HDO) of oxygen containing compounds. The amount of HDN and HDO can be controlled by adjusting the hydrotreatment conditions, such as temperature, pressure, weight hourly space velocity (WHSV) and/or catalyst.

The pre-hydrotreatment step is meant to remove a major part of the heteroatoms and those other impurities still left after the pre-treatment. In one embodiment of the present invention the amount of nitrogen can be removed by at least 80 wt. %, oxygen by at least 90 wt. % and phosphorous by at least 95 wt. % in the partly hydrotreated feed. These high levels of removal of heteroatoms and impurities shows that major part of the removal takes place in pre-hydrotreatment compared to the hydrotreatment step. Thereby, more adverse effect, such as formation of water and ammonia and catalyst de-activation, takes place in the pre-hydrotreatment step. The catalyst in the pre-hydrotreatment can be changed frequently, while the catalyst in the hydrotreatment step stays fresh. Also, fresh hydrogen can be introduced to the hydrotreatment step, which enable highly efficient conversion. Since major part of the conversion takes place in pre-hydrotreatment, the hydrotreatment step can be controlled such that the hydrotreated product is of high quality.

In the pre-hydrotreatment the partly hydrotreated feed withdrawn from the reactor, can be recycled in a relatively high ratio. The ratio of recycled partly hydrotreated feed to fresh purified feedstock in the pre-hydrotreatment step can be from 1:1 to 15:1, preferably 1:1 to 10:1 and more preferably 1:1 to 5:1.

One aim of the present method or process hereby disclosed is therefore to lower the amount of heteroatoms and impurities by a combination of pre-treatment and pre-hydrotreatment. Examples of levels of impurities before pre-treatment is given in Table 3, which also shows typical amounts of impurities still left in the feedstock prior to the pre-hydrotreatment (pre-HDO) step.

TABLE 3
Examples of levels of impurities before pre-treatment
and before pre-hydrotreatment (pre-HDO)

| | | Typical impurity levels | |
|---|---|---|---|
| | | Pre- | |
| Impurity | Unit | treatment | Pre-HDO |
| Water | wt. % | <2 | No free water |
| Chloride | ppm | <100 | <100 |
| Metals (Ca, Mg, Na, Fe), Total | ppm | <1000 | <1.5 |
| Phosphorus, Total | ppm | <500 | <1.5 |
| Nitrogen, Total | ppm | <600 | <500 |
| Silicon, Total | ppm | <100 | <2.0 |
| Solids | wt. % | <1 | To min. |

It should be noted that ppm (part per million) corresponds to mg/kg.

The hydrotreatment step if present, is performed in conditions selected from:
a temperature range of 300° C. to 380° C., preferably of 320° C. to 360° C.;
a pressure range of 40 to 80 bar, preferably 50 to 70 bar;
a weight hourly space velocity (WHSV) of 0.25 1/h to 1.5 1/h, preferably 0.3 1/h to 1 1/h; and
a H₂/oil feed of 800 dm³/dm³ to 1200 dm³/dm³, preferably of 900 dm³/dm³ to 1100 dm³/dm³.

The catalyst used in the hydrotreatment step is a typical hydrotreating catalyst such as Ni, Co, Mo, W or any combination thereof on a carrier such as alumina. Alternatively or in addition, the catalyst in the hydrotreatment can also be a typically hydrocracking catalyst such as NiW on acidic supports (ASA, Zeolites). In one embodiment the catalyst in the hydrotreatment is NiMo on alumina carrier. The treatment step is typically carried out in a reactor with one or more catalyst beds.

In the hydrotreatment the stream of hydrocarbon withdrawn from the reactor, is not or can be recycled back to the hydrotreatment, but typically in very low amount. A maximum of 10 wt. % of the stream of hydrocarbons can be recycled back to hydrotreatment. In one embodiment the hydrotreatment step does not contain any recycling.

The aim of the hydrotreatment is to essentially remove all impurities and heteroatoms from the feed, and the stream of hydrocarbons should therefore essentially only contain hydrocarbons.

The isomerization step if present is performed in conditions selected from:
a temperature range of 300° C. to 360° C., preferably 310° C. to 345° C.;
a pressure range of 35 bar to 60 bar, preferably 40 bar to 50 bar;
a weight hourly space velocity (WHSV) of 1 1/h to 1.5 1/h.

The catalyst used in the isomerization of the stream of hydrocarbons is any typical isomerization catalyst, such as Pt or Pd on a suitable support, preferably the isomerization catalyst is Pt-SAPG11.

In one embodiment of the present invention the process further comprises a stripping step to remove gaseous compounds from a stream of the process. The stripping step can be performed after the pre-treatment step, the pre-hydrotreatment step, the hydrotreatment step, the isomerization step or any combination thereof. In one embodiment the stripping is performed after the pre-hydrotreatment step to remove gaseous compounds before the distillation step. Gaseous compounds which can be removed in a stripping step include sulphide (H₂S), ammonia (NH₃) and water. The stripping step can also be called a flash step or flash evaporation or flash distillation.

In the process of the present invention said feedstock comprising organic material of biological origin has prior to the pre-treatment step preferably not been distilled or evaporated, such that the gaseous fraction is collected for further processing steps and residue or liquid fraction is discarded.

The process of the present invention further contains at least one distillation step after a first or a subsequent hydrotreatment stage, in which distillation at least two fractions are obtained, a first heavy bottom fraction, which is collected as base oil hydrocarbon product and a second middle fraction, which is subjected to further process steps or collected as middle distillate product.

The distillation step results in at least two fractions. The two fractions are a first heavy bottom fraction and a second middle fraction. The first heavy bottom fraction is collected as base oil hydrocarbon product and the middle fraction is removed from this process and can be subjected to further process steps (not disclosed) or collected separately as a middle distillate product. The first heavy bottom fraction can be characterized such that at least 90% of the components (compounds) of the first heavy bottom fraction have a boiling point of 360° C. or above. The second middle fraction can be characterized such that at least 90% of the components (compounds) of the second middle fraction have a boiling point of from 180° C. to 360° C. Alternatively, the first heavy bottom fraction can be characterized such that at least 90% of the components (compounds) of the first heavy bottom fraction have a boiling point of 340° C. or above. The second middle fraction can be characterized such that at least 90% of the components (compounds) of the second middle fraction have a boiling point of from 160° C. to 340° C. All boiling points are given in atmospheric pressure. The first heavy bottom fraction can be used as a product as such or subjected to other processes, such as purifications steps.

In one embodiment of the present invention the distillation is performed using the following conditions: a cut point target of 340° C. to 360° C., vacuum set point of 2 mbar, top column temperature of 180° C., nitrogen feed rate of 2 1/h and feed rate of 0.241/h. These conditions are to be regarded as examples and a skilled person is able to operate the distillation such that the target fractions are obtained.

In one embodiment of the present invention the distillation step is performed after the pre-hydrotreating step, after the hydrotreatment step, after the isomerisation step or any combination thereof.

In one embodiment the one or more hydrotreatment stage(s) and distillation step is performed in the following order:
c1) pre-hydrotreatment of purified feedstock to obtain a stream of partly hydrotreated feed,
d1) subjecting the stream of partly hydrotreated feed to hydrotreatment to obtain a stream of hydrotreated feed,
e1) distilling the stream of hydrotreated feed to obtain, a first heavy bottom fraction, which is collected as base oil hydrocarbon product and a second middle fraction,
f1) subjecting the collected base oil hydrocarbon product to isomerisation to obtain an isomerised hydrocarbon product.

In one embodiment the one or more hydrotreatment stage(s) and distillation step is performed in the following order:
c2) pre-hydrotreatment of purified feedstock to obtain a stream of partly hydrotreated feed,
d2) subjecting the stream of partly hydrotreated feed to hydrotreatment to obtain a stream of hydrotreated feed,
e2) subjecting the stream of hydrotreated feed to isomerisation to obtain an isomerised stream of hydrocarbons, and
f2) subjecting the isomerised stream of hydrocarbons to distillation to obtain, a first heavy bottom fraction, which is collected as base oil hydrocarbon product and a second middle fraction, which is collected as middle distillate component.

### Example

A feed of crude tall oil (CTO) including tall oil pitch (TOP) was pre-treated using heat treatment with adsorbent followed by bleaching, to reach a suitable level of impurities for pre-hydrotreatment. Impurity levels of P, Si, Fe, Na in feed after pre-treatment was below 20 ppms.

Purified feed was introduced on the pre-hydrotreatment reaction/step. Conditions in pre-hydrotreatment reaction/step were WHSV 0.3 g/h⁻¹, pressure was 50 bars, temperature was 340° C., hydrogen to oil ratio was 1150 l/l. Oil received from the process after gas separation and water stripping was recycled back with a recycle ratio of 12 times feed amount. Catalyst in the pre-hydrotreatment reaction/step was sulfided NiMo on alumina catalyst.

Conversion of nitrogen was 99.5%. Conversion of oxygen was >95%. Conversion of sulphur was 99.9%. Oil yield after gas separation and water stripping was 90%.

Oil from the pre-hydrotreatment was introduced to the hydrotreatment reaction/step. Conditions in hydrotreatment reaction/step were WHSV 0.6 g/h⁻¹, pressure was 50 bars, temperature was 350° C., hydrogen to oil ratio was 325 l/l. Catalyst in the hydrotreatment reaction/step was sulphidated NiMo on alumina catalyst.

Conversion of nitrogen was 85%. Oxygen conversion was complete (no oxygen detected). Conversion of sulphur was 98%. Oil yield after gas separation and water stripping was 100%.

Oil from the hydrotreatment was introduced to the isomerisation reaction/step. Conditions in isomerisation reaction/step were WHSV 1.5 g/h⁻¹, pressure was 40 bars, temperature was 320-330° C., hydrogen to oil ratio was 325 l/l. Catalyst in the isomerisation reaction/step was Pt-SAPO11. Oil yield after gas separation was 98 wt. %.

Two separate distillations were conducted. One distillation collected the product boiling >340° C. and the second distillation collected the product boiling >360° C. The yield of base oil in product boiling >340° C. was 35 wt. % and >360° C. was 30 wt. %

Properties of the products collected at >340° C. and >360° C. are shown in table 4 below.

TABLE 4
Table 4. Properties of base oil products

| Properties of naphtenic baseoil | | | | Product 1 | Product 2 |
|---|---|---|---|---|---|
| according to Example 1 | | | | >340° C. | >360° C. |
| ENISO12185 | Density 50° C. | | kg/m3 | 887.8 | 893.7 |
| ASTMD5950 | Pourpoint ° C. | | ° C. | −30 | −27 |
| ENISO3104 | Viscosity, | | mm2/s | 98.26 | 165.7 |
| | cSt@40° C. | | | | |
| ENISO3104 | Viscosity, | | mm2/s | 9.5 | 12.4 |
| | cSt@100° C. | | | | |
| ASTMD2270 | ViscosityIndex | | | 64.7 | 47.8 |
| ISO2977 | Anilinepoint | | ° C. | 107 | 109.7 |
| EN12916 | Monoaromates | | wt. % | 13.7 | 10.6 |
| EN12916 | Diaromates | | wt. % | 1 | 0.6 |
| EN12916 | Tri + aromates | | wt. % | 0.34 | 0.12 |
| EN12916 | Polyaromates | | wt. % | 1.6 | 0.7 |
| EN12916 | Total aromates | | wt. % | 15.2 | 11.3 |
| EN15199-2 | Simulated dist. | 0.5 | % | 346.34 | 379.55 |
| EN15199-2 | Simulated dist. | 10 | % | 377.53 | 409.69 |
| EN15199-2 | Simulated dist. | 20 | % | 407.59 | 418.22 |
| EN15199-2 | Simulated dist. | 30 | % | 417.85 | 423.7 |
| EN15199-2 | Simulated dist. | 40 | % | 423.96 | 428.17 |
| EN15199-2 | Simulated dist. | 50 | % | 428.96 | 432.77 |
| EN15199-2 | Simulated dist. | 60 | % | 434.92 | 440.91 |
| EN15199-2 | Simulated dist. | 70 | % | 455.94 | 464.76 |
| EN15199-2 | Simulated dist. | 80 | % | 484.44 | 490.52 |
| EN15199-2 | Simulated dist. | 90 | % | 532.4 | 543.79 |
| EN15199-2 | Simulated dist. | 95 | % | 574.27 | 581.45 |
| EN15199-2 | Simulated dist. | 100 | % | 661.6 | 671.58 |

It will be obvious to a person skilled in the art that, as the technology advances, the inventive concept can be implemented in various ways. The invention and its embodiments are not limited to the examples described above but may vary within the scope of the claims.

1-11. (canceled)

12. A base oil hydrocarbon composition obtained from a feedstock comprising renewable material, wherein the composition comprises:
a total paraffin content of from 50 wt. % to 65 wt. %, of which at least 90% are isomerised paraffins;
a naphthenes content of from 25 wt. % to 35 wt. %;
aromatics in an amount of 4 wt. % to 16 wt. % based on a total weight of the composition; and
wherein the composition has a pour point of −26° C. to −32° C. and a kinematic viscosity 100° C. of 7 to 17 cSt.

13. The base oil hydrocarbon composition according to claim 12, wherein the base oil hydrocarbon contains material from a feedstock containing organic material of biological origin, and/or a feedstock of biological origin which contains crude tall oil (CTO).

14. A process for producing base oil hydrocarbon product from a feedstock containing organic material of biological origin, the process comprising:
a) providing a feedstock containing organic material of biological origin;
b) pre-treating the feedstock in one or more pre-treatment stages to obtain a purified feedstock;
c) subjecting said purified feedstock to one or more hydrotreatment stage(s) to produce a hydrotreated stream; and
at least one distillation step after a first or a subsequent hydrotreatment stage, in which distillation at least two fractions are obtained, a first heavy bottom fraction which is collected as a base oil hydrocarbon product, and a second middle fraction which is subjected to further process steps and/or collected as middle distillate product.

15. A base oil hydrocarbon composition produced by a process according to claim 14.

16. The process of claim 14, wherein the feedstock containing organic material of biological origin comprises at least one or more of:
crude tall oil (CTO), tall oil pitch (TOP), tall oil fatty acid (TOFA), crude fatty acid (CFA), tall oil fatty acid (TOFA), distilled tall oil (DTO), acid oils, acidulated soapstock (ASK), technical corn oil (TCO), plant oil from plants of the family Brassicaceae (carinata oil), palm effluent sludge (PES), used cooking oil (UCO), gutter oil, brown grease (BG) and/or any combination thereof.

17. The process of claim 14, wherein the feedstock containing organic material of biological origin comprises:
an impurity level of nitrogen compounds from more than 30 ppm, up to 5000 ppm; silicon compounds from more than 1 ppm or 5 ppm, up to 500 ppm; phosphorous compounds from more than 5 ppm, up to 3500 ppm; chloride from more than 1 ppm or 5 ppm, up to 300 ppm; and/or metals from more than 10 ppm or 30 ppm, up to 20000 ppm.

18. The process of any claim 14, wherein the pre-hydrotreatment stage(s) of step b) comprises at least one or more of:
heat treatment (HT) optionally followed by evaporation of volatiles;
heat treatment with adsorbent (HTA) optionally followed by evaporation;
degumming;
bleaching and/or
any combination thereof.

19. The process according to claim 14, wherein the one or more hydrotreatment stage(s) are selected from at least one or more of:
a pre-hydrotreatment step, a hydrotreatments step, an isomerisation step and/or any combination thereof, and/or the one or more hydrotreatment stage(s) include a pre-hydrotreatment step, a hydrotreatment step and an isomerisation step.

20. The process according to claim 14, wherein the one or more hydrotreatment stage(s) and distillation step are performed in the following order:
c1) pre-hydrotreatment of purified feedstock to obtain a stream of partly hydrotreated feed;
d1) subjecting the stream of partly hydrotreated feed to hydrotreatment to obtain a stream of hydrotreated feed;
e1) distilling the stream of hydrotreated feed to obtain a first heavy bottom fraction which is collected as the base oil product, and a second middle fraction; and
f1) subjecting the collected base oil hydrocarbon product to isomerisation to obtain an isomerised base oil hydrocarbon product.

21. The process according to claim 15, wherein the one or more hydrotreatment stage(s) and distillation step are performed in the following order:
c2) pre-hydrotreatment of purified feedstock to obtain a stream of partly hydrotreated feed;
d2) subjecting the stream of partly hydrotreated feed to hydrotreatment to obtain a stream of hydrotreated feed;
e2) subjecting the stream of hydrotreated feed to isomerisation to obtain an isomerised stream of hydrocarbons; and
f2) subjecting the isomerised stream of hydrocarbons to distillation to obtain a first heavy bottom fraction which is collected as base oil hydrocarbon product, and a second middle fraction which is collected as middle distillate component.

22. The process according to claim 14, wherein the distilling is carried out such that at least 90% of the first heavy bottom fraction has a boiling point of 360° C. or above, and at least 90% of the second middle fraction has a boiling point of from 180° C. to 360° C.

23. The base oil hydrocarbon composition according to claim 12, wherein the base oil hydrocarbon composition contains material from a renewable material feedstock.

24. The process of claim 15, wherein the feedstock containing organic material of biological origin comprises at least one or more of:
crude tall oil (CTO), tall oil pitch (TOP), tall oil fatty acid (TOFA), crude fatty acid (CFA), tall oil fatty acid (TOFA), distilled tall oil (DTO), acid oils, acidulated soapstock (ASK), technical corn oil (TCO), plant oil from plants of the family Brassicaceae (carinata oil), palm effluent sludge (PES), used cooking oil (UCO), gutter oil, brown grease (BG) and/or any combination thereof.

25. The process of claim 24, wherein the feedstock containing organic material of biological origin comprises:
an impurity level of nitrogen compounds from more than 30 ppm, up to 5000 ppm; silicon compounds from more than 1 ppm or 5 ppm, up to 500 ppm; phosphorous compounds from more than 5 ppm, up to 3500 ppm; chloride from more than 1 ppm or 5 ppm, up to 300 ppm and/or metals from more than 10 ppm or 30 ppm, up to 20000 ppm.

26. The process of any claim 25, wherein the pre-hydrotreatment stage(s) of step b) comprises at least one or more of:
heat treatment (HT) optionally followed by evaporation of volatiles;
heat treatment with adsorbent (HTA) optionally followed by evaporation;
degumming;
bleaching and/or
any combination thereof.

27. The process according to claim 26, wherein the one or more hydrotreatment stage(s) are selected from at least one or more of:
a pre-hydrotreatment step, a hydrotreatments step, an isomerisation step and/or any combination thereof, and/or the one or more hydrotreatment stage(s) include a pre-hydrotreatment step, a hydrotreatment step and an isomerisation step.

28. The process according to claim 27, wherein the one or more hydrotreatment stage(s) and distillation step is performed in the following order:
c1) pre-hydrotreatment of purified feedstock to obtain a stream of partly hydrotreated feed;
d1) subjecting the stream of partly hydrotreated feed to hydrotreatment to obtain a stream of hydrotreated feed;
e1) distilling the stream of hydrotreated feed to obtain, a first heavy bottom fraction which is collected as the base oil product, and a second middle fraction; and
f1) subjecting the collected base oil hydrocarbon product to isomerisation to obtain an isomerised base oil hydrocarbon product.

29. The process according to claim 28, wherein the one or more hydrotreatment stage(s) and distillation step is performed in the following order:
c2) pre-hydrotreatment of purified feedstock to obtain a stream of partly hydrotreated feed;
d2) subjecting the stream of partly hydrotreated feed to hydrotreatment to obtain a stream of hydrotreated feed;
e2) subjecting the stream of hydrotreated feed to isomerisation to obtain an isomerised stream of hydrocarbons; and
f2) subjecting the isomerised stream of hydrocarbons to distillation to obtain a first heavy bottom fraction which is collected as base oil hydrocarbon product, and a second middle fraction which is collected as middle distillate component.

30. The process according to claim 29, wherein the distilling is carried out such that at least 90% of the first heavy bottom fraction has a boiling point of 360° C. or above, and at least 90% of the second middle fraction has a boiling point of from 180° C. to 360° C.
